(19) United States
(12) Patent Application Publication
(10) Pub. No.: US 2004/0177010 A1
(43) Pub. Date: Sep. 9, 2004

(54) Dealerstack

(76) Inventor: John Jacob Francis JR., Maple Plain, MN (US)

Correspondence Address: John J. Francis, Jr., 3201 County Road 92, Maple Plain, MN, 55359, US

(21) Appl. No.: 10/379,521

(22) Filed: Mar. 6, 2003

(51) Int. Cl. G06F 17/60

(52) U.S. Cl. 705/28

(57) ABSTRACT

DealerStack is a process for building and delivering e-commerce capability to manufacturers' sales channel partners. For the information technology art, there are five new elements in the DealerStack process for building multiple, complex, affordable e-commerce sites: 1) using dealer numbers to enable an application server to build personalized sites for each partner in a network, 2) creating a “cookbook” of discreet, repetitive tasks for building the sites using non-technical workers, 3) mapping “sliced” graphics to the size, location, and name of components in Java server pages (templates), greatly reducing the graphics production time for building multiple sites, 4) using “assembly line” techniques for scaling production to thousands of sites, and 5) achieving financial benefits of a one-to-many delivery model through the use of a one-to-many sales model (a manufacturer's co-operative marketing program).

### BACKGROUND OF THE INVENTION

This invention pertains to providing e-commerce service over the Internet.

The service is designed for a company in the manufacturing industry (“Manufacturer”) and its network of sales channel partners (“Partners”).

During the 1990s, as the Internet made its way into consumers' homes, Manufacturers began turning their backs on their Partners (distributors, retailers, contractors, agents, etc.). The general notion was that Manufacturers' sales channels were obsolete and that consumers would soon use the Internet to buy directly from Manufacturers (a concept called disintermediation). But, as Manufacturers began automating their supply chains and building web sites to offer products directly to consumers, the unexpected occurred; the majority of consumers learned to shop and compare on the Internet, but they continued to purchase products from their local businesses. These small businesses, however, lacked the information technology skills and infrastructure to service their customers over the Internet. Channel conflicts between Manufacturers and their Partners continued to grow as affordable online e-commerce solutions eluded small businesses and Manufacturers were unable to develop a vision for including their Partners in their e-business strategies.

At the same time that Manufacturers were experimenting with disintermediation, a new concept for making information technology more affordable to small businesses emerged. It was a form of outsourcing called application service provisioning and Application Service Providers (ASPs) proliferated rapidly in the late 1990s. ASPs offered access to high quality software over the Internet on a rental basis. They licensed expensive software from its developers and built capital-intensive data centers from which to rent access to the software. The ASP's financial plans were to obtain high margins on the software rentals by using a one-to-many delivery model—many renters would share the same software and infrastructure. The ASP's financial plans failed for several reasons:

(1) They failed to find one-to-many sales opportunities to match their one-to-many delivery model. Executing a sales cycle for every user drove the cost of sales much higher than forecast. The failure to find one-to-many sales opportunities was due, in part to the ASP's preference for renting the technology, rather than building and renting a service based upon the technology. This preference was a part of the “rush to market” philosophy that drove many Internet companies in the late 1990s. When offered the technology, most corporate prospects wanted to customize the software. This introduced significant delays and the additional expense of application development. It also meant that each instance of the software application would require it's own infrastructure and administrative skills. This greatly reduced the financial margins that were anticipated from sharing infrastructure and human resource skills.

(2) Convincing sales prospects that the financial benefits of outsourcing outweighed the perceived risks of renting someone else's software required a lot of time. (The fact that few small companies had the information technology skills for evaluating the services only aggravated the situation.) This drove up the cost of sales and slowed the sales cycle.

(3) The unplanned cost factors in paragraphs (1) & (2) made it impossible for the new ASPs to service the debt from their new data centers and fund larger sales teams and marketing budgets at the same time.

The consequence of disintermediation thinking and the ASP financials failures was that, throughout the 1990s, there were no viable e-commerce solutions for most small businesses. Existing e-commerce solutions were either too expensive or lacked the features and functionality necessary to compete with large retailers on the Internet. It was against this background that the DealerStack inventor, John Francis, decided to develop a process for making high-quality e-commerce technology (the same used by the Wal-Marts, Sears, and Home-Depots of the world) available to Manufacturers' smaller Partners.

This process has already been successfully implemented for the Partners of two Manufacturers in Minnesota, Honeywell and FARGO Electronics.

### BRIEF SUMMARY OF THE INVENTION

DealerStack is a process for building and delivering an affordable, high-quality e-commerce capability to Manufacturers' Partners.

The process enables an information technology service provider (“Service Provider”) to build a profitable, subscription-based service that can be offered to thousands of Partners through Manufacturers' co-operative marketing programs. By offering the service to Manufacturers for their many Partners, DealerStack targets one-to-many sales opportunities for one-to-many delivery opportunities.

The DealerStack process develops a service (rather than a technology) that can be shared by thousands of users with common business requirements. The process uses “personalization” technology to serve these thousands of Partners from a single instance of the DealerStack e-commerce application. This enables DealerStack to preserve the financial margins expected from sharing infrastructure, software and information technology skills.

The DealerStack application is designed and built with data-driven Java server pages (templates). By following the DealerStack process, the application's templates can be rapidly tailored and deployed to thousands of Partners using “assembly line” concepts.

The subscription-based service is delivered to the Partners and their customers over the Internet from the Service Provider's data center, sparing the Partners any investment in information technology skills or infrastructure.

### BRIEF DESCRIPTION OF THE SEVERAL VIEWS OF THE DRAWING (NOT APPLICABLE)

### DETAILED DESCRIPTION OF THE INVENTION

The DealerStack process consists of seven (7) sub-processes:

(1) Design a baseline e-commerce application for use by Manufacturers' Partners in a specific segment of the manufacturing industry.

(2) In collaboration with a Manufacturer and representatives of its Partners, customize and co-brand the application to fit the business model for the Manufacturer's co-operative marketing program.

(3) Deploy the application into a Service Provider's data center for information technology infrastructure and services.

(4) Populate the application's database with the Manufacturer's product content.

(5) Develop a “cookbook” of procedures for building individual e-commerce sites for the Partners. The cookbook will contain discreet tasks for configuring the application's business rules for each individual Partner and designing the look and feel to meet the Partner's branding requirements.

(6) Market the service to the Manufacturer's Partners

(7) Build the sites using assembly line techniques (each worker on the assembly line executing discreet, but repetitive, tasks in building each site). Train the Partners in the use of the online business management tools.

The first (1) sub-process in DealerStack is to design a “baseline e-commerce application” that contains the features and functionality that suit the targeted vertical slice of the manufacturing industry. The technology selected for the application must have two fundamental characteristics:

(1) The technology must be a recognized leader in the e-commerce arena, incorporating the features and functionality used by the world's leading retailers. With lesser technology, the Partners will be working with a competitive disadvantage from the beginning.

(2) The technology must incorporate “personalization” technology, enabling the application to recognize the online customer from a demographic profile, behavior or data entry (examples might include geographical region, a person who has purchased a particular item, or a person that types in a unique web address to find the web site). It is this “personalization” technology that enables the DealerStack process to deliver services to an entire network of Partners from a single instance of the application (assuming it is robust enough to handle all of the traffic that will be generated by the many Partners' customers).

The vertical manufacturing industry and its sales channels are analyzed to understand the products and the ways that they are marketed and sold. This analysis generates the requirements for the “baseline e-commerce application”. The application is developed as Java server pages (templates) and organized by functionality. These templates are used by an application server to compose and deliver the application's web pages on the fly, over the Internet, according to the business rules and content stored in the application's database. The web pages are personalized by the business rules for each Partner's community of customers, providing branding, product catalogs and pricing that are unique to each Partner's site.

The next sub-process (2) in DealerStack is to customize the “baseline e-commerce application” to fit the specific needs of the Manufacturer's sales channel. Since nearly every Manufacturer, even within a given vertical slice of the industry, has a different co-operative marketing program, this is a critical step in gaining Partners' acceptance of the new service'. First a straw-man application and mockup is built using the guidance and expertise of the Manufacturer. Then a dealer forum, or focus group, is assembled for the purpose of critiquing the straw-man and making final recommendations. The DealerStack development team finalizes the application.

The third (3) sub-process in DealerStack is for the Service Provider to deploy the application and its database into a data center that is equipped to handle the hosting requirements of a large network of customers. Typically, this will be a Tier One data center that provides data security, backup and storage, network redundancy, disaster recovery, and change management. It will also have a help desk for handling level one and two trouble tickets. It will have monitoring and reporting systems to insure the good health of the application. The architecture for the DealerStack service will be three-tier (web server, application server, and database server).

At the core of the deployment is the use of “personalization” technology to build (on-the-fly) and deliver, from hundreds of sites, the specific Partner's site that the Internet visitor requests. To facilitate this sub-process, the Service Provider assigns each Partner a “dealer number”. The dealer number is used to name an image folder on the DealerStack server that will contain all of the images to be used in a specific Partner's site. The dealer number is also used in naming sets of business rules (software code) that will guide the application server in choosing the correct images, content and templates for building that Partner's site. And finally, the dealer number is used to designate a “community” of users, those visitors who request a particular Partner's site. The Service Provider stores the names of the image folder, the business rule sets, and the community in the DealerStack database. And, it registers an Internet domain name for the Partner that is “redirected” to a web address that contains that Partner's dealer number. So, when an Internet visitor types in the web address of the Partner's site he wishes to visit, the request is redirected to a web address that contains the dealer number. When this request reaches the application server, the server opens a “session” and builds the web site (on-the-fly) using the DealerStack templates, the business rule sets, and the images in the image folder containing the dealer number matching the one in the web address. During any given server session, the visitor only receives the content of the dealer whose web address he typed into his browser. If he were to return another day and type in the web address of a different Partner, he would receive the web site of that Partner.

The fourth (4) sub-process in DealerStack is populating the application's database with the Manufacturer's product content. This may either be a manual data entry process, or if the data already exists in a Manufacturer's database, an automated one using a database upload utility.

The fifth (5) sub-process in DealerStack is developing a “cookbook” for designing and building the individual e-commerce sites for the Partners. Because the application is built on Java server pages (templates), the discreet tasks for specifying the business rules, catalog content, and graphics for each site can be identified and recorded. By careful design of the templates, these tasks are made to be repetitive and easily executable. This approach would be impossible if each Partner wanted different functionality. However, since they all are members of the same business network, they all require the same functionality. All of the Partners are in the same business (for instance—HVAC contracting). They all have need of an application designed specifically for the way their industry does business.

While most Partners may be satisfied to use the same software functionality, they demand a distinctive look and feel for their site to support their own branding. This could have been a hurdle for the “assembly line” approach. However, the DealerStack process also includes a method of providing distinctive “looks and feel” while retaining the ability to apply “assembly line” techniques. The DealerStack process specifies a common layout for all of the templates in an application. The layout for each template includes three distinct areas:

(1) Area with branding imagery and product catalog navigation.

(2) Area with a navigation menu of customer services.

(3) Area for the requested content to be displayed.

The DealerStack process facilitates the graphic individuality for each site through the use of “sliced” graphics and “cascading style sheets”. Since each of the three template areas contain the same functionality from site to site, it is possible to apply a common “sliced” graphic map to each area, even though the actual graphics may be different for each site. Each graphic “slice” controls the same functionality from site to site, even though it looks completely different. Cascading style sheets provide another method for creating diversity among the hundreds of looks and feel by permitting the text fonts, colors, and size to be aligned aesthetically with the graphics throughout the site. Editing the style sheet is a discreet task for each site.

The sixth (6) sub-process is marketing the DealerStack service to the Manufacturer's Partners. Because of the “one-to-many” sales and delivery model inherent in the DealerStack process, the Service Provider can offer the Manufacturer a unique proposition: “The Service Provider will develop and deploy the DealerStack service for the Manufacturer's Partners at no charge to the Manufacturer in exchange for the Manufacturer sponsoring the service to its Partners as a component of its co-operative marketing program.” By sponsoring the service, the Manufacturer exerts considerable influence on the Partners' choices of marketing tools. The Manufacturer offers the DealerStack service (usually rebranded as the Manufacturer's service) to its Partners as a means of reaching the product's end user without creating channel conflicts. The DealerStack marketing process is a collaboration between the Service Provider and the Manufacturer. The Service Provider provides the marketing materials (web sites, brochures, and CD-ROMs). The Manufacturer provides its sales force and access to the Partners. The Service Provider charges each Partner a nominal setup fee and low monthly subscription fee for using the DealerStack service. The Manufacturer benefits from hundreds of additional web sites on the Internet carrying its products and from the Partners's promotion of their own web sites. The details of each deal may reflect the unique characteristics of the Manufacturer's Partner program, but in the end, an affordable e-commerce solution has been provided for the Partners small-mid-sized businesses.

The seventh (7) sub-process is delivering the DealerStack service to the Partners and training them on the use of the online business management tools. A Partner subscribes to the DealerStack service through an online signup form that is connected directly to the DealerStack database. The Partner enters company information that is necessary to build their e-commerce site (point of contact, address, credit cards accepted, preferred delivery services, etc.). By submitting the online form, the Partner indicates its acceptance of the accompanying online service agreement. Upon receipt of the form, the DealerStack application automatically sends an e-mail to the Service Provider that a new customer has subscribed. This cues the new Partner's site onto the DealerStack “assembly line”.

Non-technical workers execute assigned tasks from the “cookbook” for each new e-commerce site. By passing each site from worker to worker, all of the tasks in building a site are executed in “assembly line” fashion. This makes it possible to rapidly scale site production by adding additional assembly lines, all executing the same sequence of discrete tasks. To conclude the setup, a Service Provider's trainer conducts a one-hour telephone/Internet training session with each new DealerStack subscriber (Partner). This training includes a procedures manual and focuses on the use of web-based tools for managing the database tables associated with the Partner's dealer number. Partners are trained to manage their web sites' business content; set prices, upload new products or services, and build promotions and special offers.

1. I claim to have invented a unique combination of seven (7) sub-processes for building an affordable e-commerce solution for a network of Manufacturers' Partners by incorporating the following new techniques:
a. Using a “dealer number” to enable an e-commerce application server to recognize a request for a particular Partner's web site and then to build the site on-the-fly using the business rule sets, images and templates specified in the database for that Partner's web site.
b. Creating a “cookbook” for building an e-commerce site by identifying, sequencing and documenting discreet tasks that can be performed in specifying the business rule sets, graphic images and content to be used in assembling each Partner's web site.
c. Mapping “sliced” graphics to the size, location and name of each graphic specified in the Java server pages (templates), thus providing a tool for rapidly adapting a Partner's branding materials to a new look and feel for the Partner's web site. The discreet tasks involved in “slicing” the branding materials into site graphics become part of the “cookbook”.
d. Training and organizing non-technical personnel into an “assembly line” whose members are capable of building complex e-commerce sites by executing discreet, repetitive tasks from the DealerStack “cookbook”. These “assembly lines” can be replicated and scaled to build hundreds of e-commerce sites in a short time by using a “cookbook”.
e. Designing and pricing the DealerStack service offering to be sold through a Manufacturer's co-operative marketing business unit. The service requires no information technology skills or infrastructure. It is priced within the context of other marketing tools (billboards, print advertising, trade shows). The service obligation is short term and available on a monthly subscription basis. Sign-up is easy through a one-page, online form.
